(19) United States
(12) Patent Application Publication
(10) Pub. No.: US 2026/0155937 A1
(43) Pub. Date: Jun. 4, 2026

(54) METHOD FOR DETERMINING SWITCHING DELAY, DEVICE AND STORAGE MEDIUM

(71) Applicant: Beijing Xiaomi Mobile Software Co., Ltd., Beijing (CN)

(72) Inventors: Xuemei QIAO, Beijing (CN); Qin MU, Beijing (CN)

(73) Assignee: Beijing Xiaomi Mobile Software Co., Ltd., Beijing (CN)

(21) Appl. No.: 19/122,239

(22) PCT Filed: Oct. 19, 2022
(86) PCT No.: PCT/CN2022/126277

§ 371 Date: Apr. 17, 2025

(51) Int. Cl. H04L 5/00; H04W 72/232

(52) U.S. Cl. CPC H04L 5/0053; H04W 72/232

(57) ABSTRACT

A method and system for determining a switching delay for a user equipment (UE) in a wireless communication network are disclosed. The network device determines a search space set group switching capability of the UE based on UE-reported information such as UE category or physical downlink shared channel (PDSCH) processing capability and transmits a target switching delay to the UE according to a minimum switching delay corresponding to the UE's switching capability. The switching capability may include different levels (e.g., first, second, or third switching capabilities), and the target switching delay is adjusted accordingly, with delays scaled based on UE category (e.g., first-category or second-category UE). The method may also account for sub-carrier spacing associated with the UE's bandwidth. Communication between the network and the UE includes radio resource control (RRC) signaling and downlink control signaling to coordinate switching between search space set groups.

### CROSS-REFERENCE TO RELATED APPLICATIONS

The present application is a U.S. National Stage of International Application No. PCT/CN2022/126277, filed on Oct. 19, 2022, the contents of all of which are incorporated herein by reference in their entirety for all purposes.

### BACKGROUND OF THE INVENTION

Search space set groups (SSSGs) with different periods for monitoring a physical downlink control channel (PDCCH) are configured by a network device for a user equipment (UE), to save energy at a terminal side.

### SUMMARY OF THE INVENTION

The present disclosure relates to the technical field of communication, and particularly relates to a method for determining a switching delay, a device and a storage medium.

A method for determining a switching delay is provided in a first aspect of embodiments of the present disclosure. The method is applied to a network device and includes:
determining a search space set group switching capability of a user equipment (UE); and
sending a target switching delay to the UE according to a minimum switching delay corresponding to the search space set group switching capability.

A method for determining a switching delay is provided in a second aspect of the embodiments of the present disclosure. The method is applied to a user equipment (UE) and includes:
receiving a target switching delay for switching a search space set group sent by a network device, where the target switching delay is determined by the network device according to a minimum switching delay corresponding to a search space set group switching capability of the UE.

A network device is provided in a third aspect of the embodiments of the present disclosure. The network device includes:
one or more processors, and
a memory that stores executable instructions of the one or more processors, where
the one or more processors, when execute the executable instructions, are collectively configured to:
determine a search space set group switching capability of a user equipment (UE); and
send a target switching delay to the UE according to a minimum switching delay corresponding to the search space set group switching capability.

A user equipment (UE) is provided in a fourth aspect of the embodiments of the present disclosure. The UE includes:
one or more processors, and
a memory that stores executable instructions of the one or more processors, where
the one or more processors, when execute the executable instructions, are collectively configured to implement steps of the method for determining the switching delay according to the second aspect of the embodiments of the present disclosure.

A non-transitory computer-readable storage medium is provided in a fifth aspect of the embodiments of the present disclosure. The non-transitory computer-readable storage medium stores computer program instructions. The program instructions, when executed by a processor, implement steps of the method for determining the switching delay according to the first aspect of the embodiments of the present disclosure.

### BRIEF DESCRIPTION OF DRAWINGS

FIG. 1 is a flowchart of a method for determining a switching delay according to an example;

FIG. 2 is a flowchart of a method for determining the switching delay according to an example;

FIG. 3 is a flowchart of a method for determining the switching delay according to an example;

FIG. 4 is a flowchart of a method for determining the switching delay according to an example;

FIG. 5 is a flowchart of a method for determining the switching delay according to an example;

FIG. 6 is a flowchart of a method for determining the switching delay according to an example;

FIG. 7 is a flowchart of a method for determining the switching delay according to an example;

FIG. 8 is a flowchart of a method for determining the switching delay according to an example;

FIG. 9 is a flowchart of a method for determining the switching delay according to an example;

FIG. 10 is a flowchart of a method for determining the switching delay according to an example;

FIG. 11 is a flowchart of a method for determining the switching delay according to an example;

FIG. 12 is a flowchart of a method for determining the switching delay according to an example;

FIG. 13 is a flowchart of a method for determining the switching delay according to an example;

FIG. 14 is a block diagram of a first device for determining the switching delay according to an example;

FIG. 15 is a block diagram of a second device for determining the switching delay according to an example;

FIG. 16 is a block diagram of a user equipment according to an example; and

FIG. 17 is a block diagram of a network device according to an example.

### DETAILED DESCRIPTION OF THE INVENTION

Description will be made in detail to examples here, and their instances are illustrated in the accompanying drawings. When the following description relates to the accompanying drawings, the same numbers in different accompanying drawings denote the same or similar elements, unless indicated otherwise. The implementations described in the following examples do not represent all implementations consistent with the present disclosure. Rather, they are merely instances of devices and methods consistent with some aspects of the present disclosure as detailed in the appended claims.

It may be understood that in the present disclosure, “a plurality of” refers to two or more, and other quantifiers are understood in a similar way. The term “and/or” is used to describe an associated relation between associated objects and indicates that there may be three relations. For example, A and/or B may indicate three situations: A exists alone, A and B exist at the same time, and B exists alone. The character “/” generally indicates that the associated objects are in an “or” relation. Singular forms “a,” “an” and “the” are intended to include plural forms as well, unless the context clearly indicates otherwise.

It may be further understood that the terms “first,” “second,” etc. are used to describe various information, but the information should not be limited by these terms. These terms are merely used to distinguish the same type of information from each other, and do not denote any specific order or importance. Indeed, the expressions “first,” “second,” etc. may be used interchangeably.

It may be further understood that in embodiments of the present disclosure, while operations are depicted in the drawings in a particular order, it should not be understood as requiring that such operations be executed in the particular order shown or in serial order, or that all illustrated operations be executed, to achieve desirable results. In certain circumstances, multitasking and parallel processing may be advantageous.

It should be noted that in the present application, all the actions of obtaining a signal, information or data are performed under the premise of complying with corresponding data protection laws and regulations of the country where they are located and obtaining the authorization given by an owner of a corresponding device.

Search space set groups (SSSGs) with different periods for monitoring a physical downlink control channel (PDCCH) are configured by a network device for a user equipment (UE), to save energy at a terminal side. When uplink and downlink services are dense, the PDCCH is monitored with a dense period configuration. The network device can configure a plurality of search space sets as different search space set groups (SSSGs), and indicate the UE via the PDCCH to use the configuration of which SSSG to monitor the PDCCH. The network device can directly trigger the UE to switch a SSSG via the PDCCH, and the UE switches the SSSG according to a switching delay configured by the network device.

In the related art, the processing capability of the UE is reduced in order to save the cost of the UE. However, if the network device configures the switching delay for the UE in accordance with a processing capability of a traditional UE, the UE, with a reduced processing capability of the UE, is unable to complete switching between the SSSGs with a short configuration delay.

For ease of understanding, terms involved in the present disclosure are introduced at first.
1. Physical downlink shared channel (PDSCH). The PDSCH is configured to carry a downlink higher-layer control signaling and user data.
2. Physical uplink shared channel (PUSCH). The PUSCH is configured to carry an uplink higher-layer control signaling or a physical layer control signaling, and the user data.
3. Physical uplink control channel (PUCCH). The PUCCH is configured to carry an acknowledgement (ACK) message or a negative acknowledgement (NACK) message for a hybrid automatic repeat request (HARQ).
4. Physical downlink control channel (PDCCH). The PDCCH transmits downlink control information (DCI) related to physical uplink and downlink shared channels (PUSCH, PDSCH). The DCI includes several related contents such as resource block (RB) allocation information, and the HARQ. The UE can correctly process PDSCH data or PUSCH data only if the DCI is correctly decoded.
5. Band width part (BWP). The BWP is one subset bandwidth of a channel bandwidth of the UE. A size of a bandwidth received and sent by the UE is flexibly adjusted via bandwidth adaptation in new radio (NR), such that the bandwidth received and sent by the UE does not need to be as large as the bandwidth of a cell. The UE can activate only one uplink (UL) BWP and one downlink (DL) BWP at the same time. Each BWP is configured with one sub-carrier spacing (SCS). Unless otherwise specified, all signals and channels on the BWP adopt the SCS.
6. Search space set group (SSSG). The UE uses the SSSG to monitor the PDCCH. The UE may switch the SSSG by two methods. Method 1 is that a network device triggers the UE to switch the SSSG via the PDCCH. Method 2 is that the UE is triggered to switch the SSSG via a timer. For example, the PDCCH is monitored by using a configuration of one SSSG during running of the timer, and the PDCCH is monitored by using another SSSG when running of the timer expires.

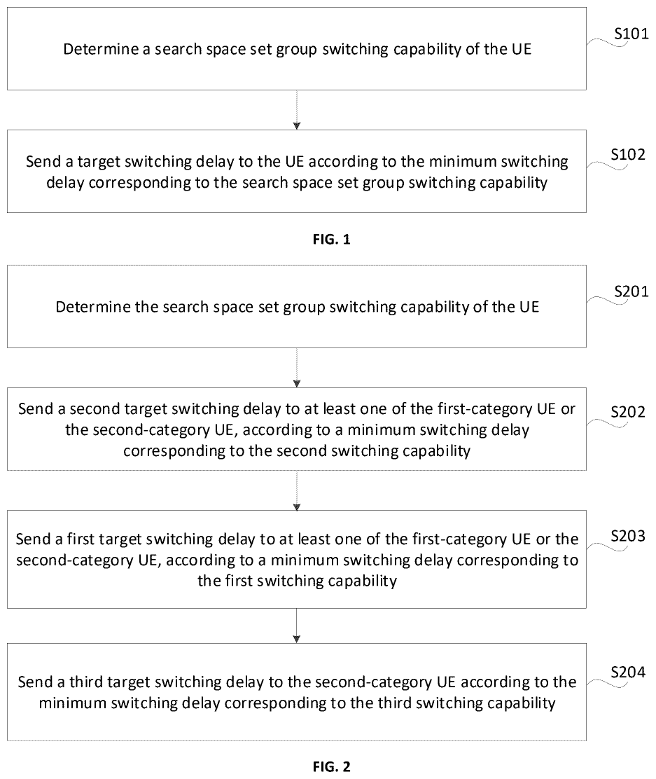

FIG. 1 is a flowchart of a method for determining a switching delay according to an example. The method for determining the switching delay is applied to the network device. As shown in FIG. 1, the method for determining the switching delay includes the following steps.

In S101, a search space set group switching capability of the UE is determined.

The UE provided in any embodiment of the present disclosure may be a mobile phone, a tablet, a portable computer, a computer with a wireless transceiving function, a virtual reality (VR) UE, an augmented reality (AR) UE, a wireless terminal in industrial control, the wireless terminal in a smart grid, a wireless terminal in transportation safety, a wireless terminal in a smart city, a wireless terminal in a smart home. The present disclosure does not limit an application scenario. The UE may also be referred to as a user equipment, a terminal, an access terminal, a UE unit, a UE station, a mobile device, a mobile radio station, a mobile station, a mobile client, etc.

The network device proposed in any embodiment of the present disclosure may be a device for communicating with the UE. The network device may also be referred to as an access network device or a wireless access network device, and may be a transmission reception point (TRP), an evolved NodeB (eNB or eNodeB) in a long term evolution (LTE) system, a home base station (for example, home evolved NodeB, or home Node B (HNB)), a base band unit (BBU), and a wireless controller in a cloud radio access network (CRAN) scenario. Alternatively, the network device may be a relay station, an access point, a vehicle-mounted device, a wearable device, the network device in a 5th-generation (5G) network, or a network device in a future evolved public land mobile network (PLMN) network, etc., may be an access point (AP) in a wireless local area network (WLAN), and may be a next generation Node B (gNB) of the NR, which is not limited in the embodiment of the present application.

The switching capability is a capability of the UE for switching the SSSG. The switching capability is positively correlated with a processing capability of the UE. The higher the processing capability of the UE is, the higher the switching capability of the UE for switching the SSSG is, and the shorter a delay of the UE for switching the SSSG is. In the following description, the switching capability will be referred to as the processing capability. One serving cell may access a plurality of categories of the UE such as a first-category UE and a second-category UE.

The first-category UE is the UE with an unrelaxed processing capability. For example, the first-category UE (non-eRedCap UE) may be the UE (RedCap UE) with a normally reduced capability, a normal user equipment (Normal UE), etc. The UE with the unrelaxed processing capability is the UE whose processing capability for a physical layer channel or a physical layer signal is unrelaxed, that is, the UE with a non-reduced or normally reduced processing capability, and the switching delay for switching the SSSG is short.

The second-category UE may be the UE with a relaxed processing capability, for example, the UE (eRedCap UE) with an evolved reduced processing capability in 3GPP Release 18 (R18) and later versions. The UE with the relaxed processing capability is the UE whose processing capability for the physical layer channel or the physical layer signal is relaxed. The processing capability of the UE with the relaxed processing capability is reduced compared with the processing capability of the UE with the unrelaxed processing capability. Accordingly, the switching delay of the UE with the relaxed processing capability for switching the SSSG is longer compared with the switching delay of the UE with the unrelaxed processing capability for switching the SSSG.

In the two categories of the UE, namely the non-eRedCap UE and the eRedCap UE, for the processing capability of each UE, a relation may be that a minimum processing capability of the non-eRedCap UE is greater than the minimum processing capability of the eRedCap UE. For the switching delay of each UE for switching the SSSG, a relation may be that a minimum switching delay corresponding to the minimum processing capability of the non-eRedCap UE is less than the minimum switching delay corresponding to the minimum processing capability of the eRedCap UE.

The switching delay is a switching duration allocated by the network device for the UE to switch the SSSG. The switching delay is influenced by a PDCCH blind detection delay and a PUCCH preparation delay, both of which are related to a PDSCH processing delay. The PDSCH processing delay includes the PDCCH blind detection delay, a PDSCH decoding delay and the PUCCH preparation delay. The longer the PDSCH processing delay is, the longer the corresponding switching delay for switching SSSG is. Therefore, when the network device allocates the switching delay for switching the SSSG to the UE, the PDSCH processing duration of the UE needs to be considered.

In S102, a target switching delay is sent to the UE according to the minimum switching delay corresponding to the search space set group switching capability.

The UEs with different SSSG processing capabilities correspond to different minimum switching delays. The UE with a same processing capability corresponds to a plurality of minimum switching delays. The plurality of minimum switching delays are equal or not.

For example, the minimum switching delays corresponding to the UEs with different processing capabilities are shown in Table 1.

TABLE 1
Minimum switching delay value

| | Minimum switching delay | Minimum switching delay |
|---|---|---|
| | corresponding to first | corresponding to second |
| | processing capability | processing capability |
| μ | [symbols] | [symbols] |
| 0 | 25 | 10 |
| 1 | 25 | 12 |
| 2 | 25 | 22 |

It may be understood that each element and each corresponding relation in Table 1 are independent, and these elements and corresponding relations are illustratively listed in the same table, but it does not mean that all the elements and corresponding relations in the table must be present simultaneously as shown in Table 1. A value of each element and each corresponding relation are independent of a value of any other element or corresponding relation in Table 1. Therefore, those skilled in the art may understand that the value of each element or each corresponding relation in Table 1 is an independent embodiment.

The minimum switching delay of the first-category UE is not limited to the values listed in Table 1, but may also be another value. The present disclosure does not further enumerate other values of the minimum switching delays of both the second-category UE and the first-category UE.

In Table 1, the plurality of minimum switching delays under the first processing capability are provided, and the plurality of minimum switching delays are equal. The plurality of minimum switching delays under the second processing capability are provided, and the plurality of minimum switching delays are different. Since the first processing capability is less than the second processing capability, the plurality of minimum switching delays corresponding to the first processing capability are greater than the plurality of minimum switching delays corresponding to the second processing capability. The symbols in Table 1 are orthogonal frequency division multiplexing (OFDM) symbols.

There is a corresponding relation between a μ value of the UE in Table 1 and sub-carrier spacing of a current BWP of the UE.

Illustratively, the μ value of the UE may be obtained by the following formula (1).

$$Δ f = {2}^{u} * 15 \qquad ( 1 )$$

Δf is the sub-carrier spacing. μ is the μ value of the UE, and may be 0, 1, 2, 3, 4, . . . .

It can be seen from formula (1) that after determining the sub-carrier spacing of the current BWP of the UE, the network device may determine the μ value of the UE, and then determine a row in Table 1 according to the μ value of the UE. After determining the search space set group switching capability of the UE, the network device may determine a column in Table 1, and determine one minimum switching delay according to the determined row and column.

The minimum switching delay corresponding to the first processing capability and the second processing capability may be the minimum switching delay applicable to the first-category UE, that is, the UE with the unrelaxed processing capability. The RedCap UE and the Normal UE have the same processing capability. The RedCap UE may have the first processing capability and the second processing capability, and the Normal UE may also have the first processing capability and the second processing capability. In the related art, in order to reduce energy consumption of the first-category UE, the PDSCH processing capability of the first-category UE is reduced, such that the PDSCH processing duration of the first-category UE is relaxed to N times of original PDSCH processing duration. After the PDSCH processing duration is relaxed, the PDCCH blind detection delay is also relaxed. For example, a bandwidth of the eRedCap UE with the evolved reduced processing capability under an R18 standard is further reduced to 5 MHz compared with bandwidths of the UE (RedCap UE) with the normally reduced capability and the normal user equipment (Normal UE) under an Release 17 (R17) standard, and the PDSCH processing duration is also relaxed, such that the processing capability of the UE under the R18 standard is lower than the processing capability of the UE under the R17 standard and an Release 16 (R16) standard.

However, after the first-category UE with the unrelaxed processing capability evolves into the second-category UE with the relaxed processing capability, in a case where the network device still allocates the switching delay to the second-category UE according to the minimum switching delay needed by the first-category UE, the switching delay allocated by the network device cannot be aligned with the switching delay needed by the second-category UE. That is, the switching delay allocated by the network device to the second-category UE may be less than the switching delay needed by the second-category UE. In this case, the second-category UE with a lower processing capability cannot switch the SSSG due to the lower switching delay. That is, the lower processing capability of the second-category UE cannot support SSSG switching with the less switching delay.

In order to avoid the situation that the switching delay allocated by the network device is not aligned with the switching delay needed by the second-category UE, one column of minimum switching delays may be redefined in the network device, and reference may be made to Table 2 below for specific details.

TABLE 2
Minimum switching delay value

| | Minimum switching | Minimum switching | Minimum switching |
|---|---|---|---|
| | delay corresponding | delay corresponding | delay corresponding |
| | to third processing | to first processing | to second processing |
| | capability | capability | capability |
| μ | [symbols] | [symbols] | [symbols] |
| 0 | M1 | 25 | 10 |
| 1 | M2 | 25 | 12 |
| 2 | M3 | 25 | 22 |

It may be understood that each element and each corresponding relation in Table 2 are independent, and these elements and corresponding relations are illustratively listed in the same table, but it does not mean that all the elements and corresponding relations in the table must be present simultaneously as shown in Table 2. A value of each element and each corresponding relation are independent of a value of any other element or corresponding relation in Table 2. Therefore, those skilled in the art may understand that the value of each element or each corresponding relation in Table 2 is an independent embodiment.

The minimum switching delay of the second-category UE in Table 2 is not limited to M1, M2 and M3, but may also be values represented by other symbols. Table 2 is only an example. The minimum switching delay of the first-category UE is not limited to the values listed in Table 2, but may also be another value. The present disclosure does not further enumerate other values of the minimum switching delays of both the second-category UE and the first-category UE. The symbols in Table 1 are orthogonal frequency division multiplexing (OFDM) symbols.

In Table 2, the plurality of minimum switching delays M1, M2, M3, etc. which are equal or not are provided under the third processing capability, and the UE with the third processing capability may be the second-category UE with the relaxed processing capability. In a case where the μ value of the second-category UE is 0, the network device determines the minimum switching delay of the second-category UE to be M1. In a case where the μ value of the second-category UE is 1, the network device determines the minimum switching delay of the second-category UE to be M2. In a case where the y value of the second-category UE is 2, the network device determines the minimum switching delay of the second-category UE to be M3. M1, M2 and M3 may be equal or not. M1, M2 and M3 are all greater than the minimum switching delay of the first-category UE. For example, M1, M2 and M3 have greater minimum switching delays than the first processing capability.

After the minimum switching delay of the second-category UE is defined, in a case where the network device determines that the search space set group switching capability of the UE is the third switching capability, the target switching delay is sent to the second-category UE according to the minimum switching delay corresponding to the third switching capability.

The target switching delay sent by the network device is greater than or equal to the minimum switching delay, and less than a maximum switching delay. The maximum switching delay may be 52 or another value, which is not limited in the present disclosure.

For example, in a case where the network device determines the minimum switching delay to be M1, one target switching delay may be determined within an integer range of [M1, 52] according to a scheduling status of the network device, and the target switching delay is sent to the UE.

By the above technical solutions, the network device may determine the SSSG switching capability of the UE, determine the minimum switching delay corresponding to the SSSG switching capability, and send the target switching delay to the UE according to the minimum switching delay. In this process, after the processing capability of the UE is reduced, the network device may also re-determine the processing capability of the UE, and send the target switching delay to the UE according to the minimum switching delay corresponding to a reduced processing capability of the UE. So that the UE with the reduced processing capability can receive the corresponding target switching delay, and a situation that the target switching delay needed by the UE is not aligned with the target switching delay configured by the network device can be avoided.

FIG. 2 is a flowchart of a method for determining the switching delay according to an example. The method for determining the switching delay is applied to the network device. As shown in FIG. 2, the method for determining the switching delay includes the following steps.

In S201, the search space set group switching capability of the UE is determined.

Reference may be made to S101 for an embodiment of this step, which is not repeated here.

Switching capabilities include at least one of a first switching capability, a second switching capability or a third switching capability. The UE includes at least one of first-category UE and second-category UE. The target switching delay is sent to the UE according to the minimum switching delay corresponding to the search space set group switching capability. This process includes at least one of S202, S203 or S204.

In S202, a second target switching delay is sent to at least one of the first-category UE or the second-category UE, according to a minimum switching delay corresponding to the second switching capability.

The first-category UE is the UE with the unrelaxed processing capability, for example, the normal user equipment (Normal UE), and the RedCap UE with the normally reduced processing capability. The second-category UE is UE with the relaxed processing capability, for example, the eRedCap UE with the evolved reduced processing capability.

The second switching capability or the second processing capability may be the unrelaxed processing capability, and is applicable to the normal user equipment (Normal UE) with the unrelaxed processing capability. In a case where the processing capability of the Normal UE is reduced, the Normal UE evolves into the RedCap UE, and the second switching capability is applicable to the RedCap UE with the normally reduced processing capability. In a case where the processing capability of the RedCap UE is reduced and the RedCap UE evolves into the eRedCap UE, the second switching capability is applicable to the eRedCap UE with the evolved reduced processing capability.

It can be understood that the second target switching delay may be an unrelaxed switching delay, and is applicable to the normal user equipment (Normal UE) with the unrelaxed processing delay. In a case where the processing delay of the Normal UE is relaxed and the Normal UE evolves into the RedCap UE, the second target switching delay is applicable to the RedCap UE with the normally reduced processing capability. In a case where the processing delay of the RedCap UE is relaxed and the RedCap UE evolves into the eRedCap UE, the second target switching delay is applicable to the eRedCap UE with the evolved reduced processing capability. Therefore, the second target switching delay obtained according to the minimum switching delay corresponding to the second switching capability is applicable to at least one of the first-category UE or the second-category UE.

It can be understood that when the Normal UE evolves into the RedCap UE, the RedCap UE has two processing capabilities. The RedCap UE may not relax the processing capability or may normally reduce the processing capability. In a case where the RedCap UE evolves into the eRedCap UE, the eRedCap UE has three processing capabilities. The eRedCap UE may evolve to reduce the processing capability, that is, further reduce the processing capability compared with the normally reduced processing capability, or normally reduce the processing capability, or not reduce the processing capability.

For example, the second-category UE is the UE with the evolved reduced capability based on the first-category UE, such that the second switching capability applicable to the first-category UE is also applicable to the second-category UE.

In response to determining that the SSSG switching capability of the UE is the second switching capability, the first target switching delay may be sent to at least one of the first-category UE or the second-category UE according to the minimum switching delay corresponding to the second switching capability.

Illustratively, in response to determining that the SSSG switching capability of the UE is the second switching capability, the second target switching delay may be sent to the UE according to the plurality of minimum switching delays, such as 10, 12 and 22, corresponding to the second processing capability in Table 2. The UE is at least one of the first-category UE or the second-category UE.

In S203, a first target switching delay is sent to at least one of the first-category UE or the second-category UE, according to a minimum switching delay corresponding to the first switching capability.

The first switching capability or the first processing capability may be a normally relaxed processing capability. The first switching capability is less than the second switching capability, or the first processing capability is less than the second processing capability. The first switching capability is applicable to the RedCap UE, which normally has a reduced processing capability. In a case where the processing capability of the RedCap UE is reduced and the RedCap UE evolves into the eRedCap UE, the first switching capability is applicable to the eRedCap UE with the evolved reduced processing capability.

It can be understood that the first target switching delay may be a normally relaxed switching delay and is applicable to the RedCap UE. In a case where the processing delay of the RedCap UE is relaxed and the RedCap UE evolves into the eRedCap UE, the first target switching delay is applicable to the eRedCap UE with the evolved reduced processing capability. Therefore, the first target switching delay obtained according to the minimum switching delay corresponding to the first switching capability is applicable to at least one of the first-category UE or the second-category UE.

For example, the second-category UE is the UE with the evolved reduced capability based on the first-category UE, such that the first switching capability applicable to the first-category UE is also applicable to the second-category UE.

In response to determining that the SSSG switching capability of the UE is the first switching capability, the first target switching delay may be sent to at least one of the first-category UE or the second-category UE according to the minimum switching delay corresponding to the first switching capability.

Illustratively, in response to determining that the SSSG switching capability of the UE is the first switching capability, the first target switching delay greater than or equal to 25 may be sent to the UE according to the minimum switching delay 25 corresponding to the first processing capability in Table 2. The UE is at least one of the first-category UE or the second-category UE.

The minimum switching delay corresponding to the first processing capability is greater than the minimum switching delay corresponding to the second processing capability, the first target switching delay is greater than the minimum switching delay corresponding to the first processing capability, and the second target switching delay is greater than the minimum switching delay corresponding to the second processing capability, such that the first target switching delay is greater than the second target switching delay.

In S204, a third target switching delay is sent to the second-category UE according to the minimum switching delay corresponding to the third switching capability.

The third switching capability or the third processing capability may be an evolved relaxed processing capability. The third switching capability is less than the first switching capability, or the third processing capability is less than the first processing capability. The third switching capability is applicable to the second-category UE with the evolved reduced processing capability, such as the eRedCap UE. Since the RedCap UE and the Normal UE of the first-category UE are the UE with the unrelaxed processing capability and the UE with the unrelaxed processing capability does not have the evolved relaxed processing capability, the third switching capability cannot be applied to the RedCap UE and the Normal UE of the first-category UE.

In response to determining that the SSSG switching capability of the UE is the third switching capability, the third target switching delay may be sent to the second-category UE according to the minimum switching delay corresponding to the third switching capability.

Illustratively, in response to determining that the SSSG switching capability of the UE is the third switching capability, the third target switching delay may be sent to the UE according to minimum switching delays, such as M1, M2 and M3, corresponding to the third processing capability in Table 2. The UE is the second-category UE.

The minimum switching delay corresponding to the third processing capability is greater than the minimum switching delay corresponding to the first processing capability, the third target switching delay is greater than the minimum switching delay corresponding to the third processing capability, and the first target switching delay is greater than the minimum switching delay corresponding to the first processing capability, such that the third target switching delay is greater than the first target switching delay.

Illustratively, after determining the second switching capability of any one of the Normal UE, the RedCap UE and the eRedCap UE, the network device sends the second target switching delay to the UE according to the minimum switching delay corresponding to the second switching capability. After determining the first switching capability of any one of the RedCap UE and the eRedCap UE, the network device sends the first target switching delay to the UE according to the minimum switching delay corresponding to the first switching capability. After determining the third switching capability of the eRedCap UE, the network device sends the third target switching delay to the UE according to the minimum switching delay corresponding to the third switching capability. It can be understood that the network device determines the switching capability of which UE, and sends the target switching delay to that UE.

It can be understood that there is no sequential relation among S202, S203 and S204. After the search space set group switching capability of the UE is determined, any one of S202, S203 and S204 may be performed.

By the above technical solutions, in response to determining that the processing capability of the first-category UE is the first switching capability or the second switching capability, the network device sends the first target switching delay or the second target switching delay to the first-category UE according to the minimum switching delay corresponding to the first switching capability or the second switching capability. In response to determining that the processing capability of the second-category UE is the first switching capability, the second switching capability or the third switching capability, the network device sends the first target switching delay, the second target switching delay or the third target switching delay to the second-category UE according to the minimum switching delay corresponding to the first switching capability, the second switching capability or the third switching capability. Accordingly, the first-category UE and the second-category UE, with different processing capabilities, can obtain corresponding target switching delays. A situation that the target switching delay configured by the network device is not aligned with the switching delay needed by the UE is avoided.

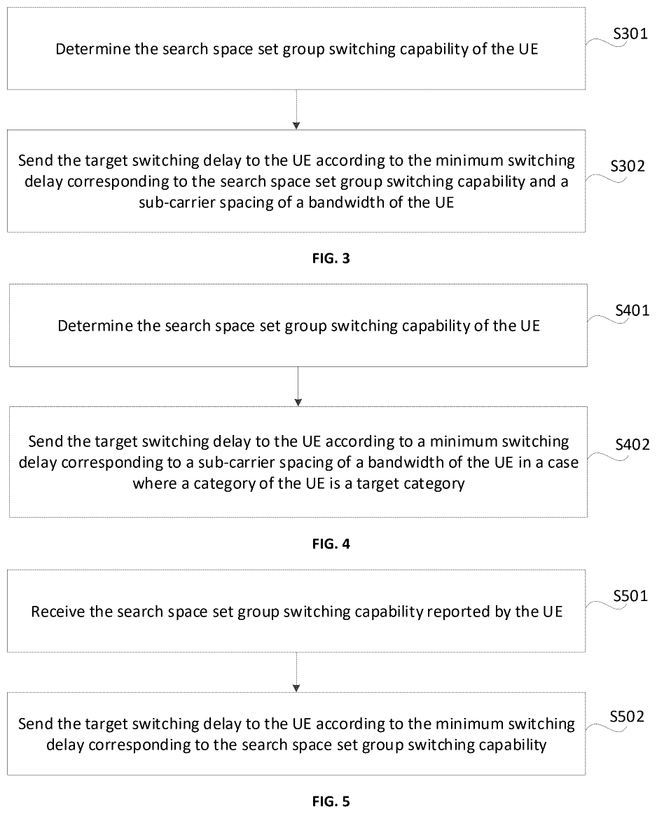

FIG. 3 is a flowchart of a method for determining the switching delay according to an example. The method for determining the switching delay is applied to the network device. As shown in FIG. 3, the method for determining the switching delay includes the following steps.

In S301, the search space set group switching capability of the UE is determined.

Reference may be made to S101 for an embodiment of this step, which is not repeated here.

In S302, the target switching delay is sent to the UE according to the minimum switching delay corresponding to the search space set group switching capability and a sub-carrier spacing of a bandwidth of the UE.

In a case where there are at least two categories of UE within a network coverage range of the network device, one minimum switching delay needs to be determined according to the SSSG switching capability of the UE and the sub-carrier spacing of the BWP of the UE, and the target switching delay is sent to the UE according to the minimum switching delay.

For example, in a case where the UE within the network coverage range of the network device has three categories of the UE, that is, the Normal UE, the RedCap UE and the eRedCap UE, which are included in the first-category UE and the second-category UE. In a case where sub-carrier spacings of BWPs of the three categories of the UE are all 100 KHz, the network device cannot determine that the configured target switching delay belongs to which category of the UE only according to the sub-carrier spacing 100 KHz. In a case where the network device determines that the processing capability of the UE is the third processing capability only, since the plurality of minimum switching delays are provided under the third processing capability, the network device cannot determine the needed minimum switching delay from the plurality of minimum switching delays.

In order to determine the needed minimum switching delay in a case where the plurality of categories of the UE exist, one minimum switching delay needs to be determined according to the SSSG switching capability of the network device and the sub-carrier spacing of the BWP of the UE.

With reference to the formula (1), after the sub-carrier spacing of the BWP of the UE is determined, the μ value of the UE may be determined, and then a row in Table 2 may be determined. After the processing capability of the UE is determined, a column in Table 2 may be further determined, and finally one minimum switching delay may be determined according to the μ value of the UE and the sub-carrier spacing of the BWP.

For example, in response to determining that the μ value of the UE is 1, and the processing capability of the UE is the third processing capability, the minimum switching delay of the UE may be determined to be M2. A target switching delay greater than or equal to M2 is sent to the UE.

The network device and the UE unify the corresponding relation among the processing capability of the UE, the μ value of the UE, and the minimum switching delay. That is, the corresponding relation among the processing capability of the UE, the μ value of the UE, and the minimum switching delay shown in Table 2 is defined in both the network device and the UE. For example, the corresponding relation among the μ value of the UE, the third processing capability, and the minimum switching delay is defined in both the network device and the UE. In this way, after determining the processing capability of the UE and the μ value of the UE, the network device may directly determine the minimum switching delay, and then return the needed target switching delay to the UE.

In any embodiment of the present disclosure, when the target switching delay is sent, a value needs to be within a value range between the minimum processing delay and the maximum processing delay, that is, the value range is greater than or equal to the minimum processing delay and less than the maximum processing delay, according to a scheduling situation of the network device.

The plurality of minimum switching delays under the third processing capability are greater than the plurality of minimum switching delays under the first processing capability. For example, the plurality of minimum switching delays under the third processing capability may be N times of the plurality of minimum switching delays under the first processing capability. The plurality of minimum switching delays under the third processing capability may also be sums of the plurality of minimum switching delays under the first processing capability and a preset value. The preset value is a positive number.

The minimum switching delay corresponds to the processing capability of the UE, and is a delay that the UE can switch the SSSG in a fastest manner under a current processing capability. Certainly, the UE may also switch the SSSG with a delay greater than or equal to the minimum switching delay, that is, with a delay slower than the minimum switching delay. Accordingly, the network device may configure a target switching delay greater than or equal to the minimum switching delay for the UE. It can be understood that the UE cannot switch the SSSG by using the switching delay that does not match the processing capability of the UE. For example, the UE cannot switch the SSSG by using the target switching delay that is less than the minimum switching delay.

By the above technical solutions, in a case where there are at least two categories of the UE within the network coverage range of the network device, one minimum switching delay may be determined from the plurality of minimum switching delays according to the SSSG switching capability of the network device and the sub-carrier spacing of the BWP of the UE, and then the target switching delay greater than or equal to the minimum switching delay is sent to the UE.

FIG. 4 is a flowchart of a method for determining the switching delay according to an example. The method for determining the switching delay is applied to the network device. As shown in FIG. 4, the method for determining the switching delay includes the following steps.

In S401, the search space set group switching capability of the UE is determined.

Reference may be made to S101 for an embodiment of this step, which is not repeated here.

In S402, the target switching delay is sent to the UE according to a minimum switching delay corresponding to a sub-carrier spacing of a bandwidth of the UE in a case where a category of the UE is a target category.

In a case where the category of the UE within the network coverage range of the network device is only the target category, the network device is aware of the processing capability of the UE of the target category and does not need to determine the processing capability of the UE, such that the UE can determine one minimum switching delay according to the sub-carrier spacing of the current BWP of the UE.

The target category may be the Normal UE and the RedCap UE included in the first-category UE, or the eRedCap UE included in the second-category UE.

The processing capability of the UE of the target category is preset in the network device.

Illustratively, in a case where the UE within the network coverage range of the network device only has the Normal UE, and the sub-carrier spacing of the UE is 100 KHz, the network device is aware of that the processing capability of the Normal UE is the second processing capability. In this case, according to the sub-carrier spacing 100 KHz of the Normal UE, the μ value of the Normal UE may be determined to be 2, and then the minimum switching delay corresponding to 2 may be determined to be 22.

Illustratively, in a case where the UE within the network coverage range of the network device only has the eRedCap UE, and the sub-carrier spacing of the UE is 100 KHz, the network device is aware of that the processing capability of the eRedCap UE is the third processing capability. In this case, according to the sub-carrier spacing 100 KHz of the eRedCap UE, the μ value of the Normal UE may be determined to be 2, and then the minimum switching delay corresponding to 2 may be determined to be M3.

By the technical solutions, in a case where the UE within the coverage range of the network device only has the target category, the processing capability of the UE of the target category may be preset in the network device. When the network device needs to allocate the target switching delay to the UE, only the μ value of the UE needs to be determined according to the sub-carrier spacing, and then the minimum switching delay corresponding to the μ value may be determined from the plurality of minimum switching delays under the preset processing capability of the UE according to the μ value. The processing capability of the UE does not need to be determined. That is, the UE does not need to report the processing capability of the UE to the network device.

FIG. 5 is a flowchart of a method for determining the switching delay according to an example. The method for determining the switching delay is applied to the network device. As shown in FIG. 5, the method for determining the switching delay includes the following steps.

In S501, the search space set group switching capability reported by the UE is received.

In a case where the first-category UE has the first switching capability and the second switching capability, the second-category UE has the first switching capability, the second switching capability, and the third switching capability, the network device needs to determine a switching capability currently used by the UE, the SSSG switching capability of the UE may be reported to the network device by the UE, and the SSSG switching capability of the UE may be determined explicitly. The network device may directly receive the SSSG switching capability reported by the UE. The SSSG switching capability includes any one of the first switching capability, the second switching capability, and the third switching capability.

The network device defines in advance a corresponding relation between the plurality of minimum switching delays under the first switching capability and the μ value of the UE, a corresponding relation between the plurality of minimum switching delays under the second switching capability and the μ value of the UE, and a corresponding relation between the plurality of minimum switching delays under the third switching capability and the μ value of the UE. After receiving the SSSG switching capability reported by the UE, the network device may determine the plurality of minimum switching delays corresponding to the SSSG switching capability.

The SSSG switching capability reported by the UE is the current switching capability or the current processing capability of the UE. When reporting the switching capability, the UE may directly inform the network device of the switching capability of the UE explicitly.

For example, the RedCap UE of the first-category UE may inform the network device of the switching capability of the RedCap UE via UE capability signaling searchSpaceSwitchCapability2-R16 or searchSpaceSetGrp-switchCap2-R17. The SSSG switching capability indicated in the UE capability signaling.

Illustratively, the eRedCap UE of the second-category UE may inform the network device of the switching capability of the eRedCap UE via radio resource control (RRC) signaling searchSpaceSetGrp-switchCap0-R18. The SSSG switching capability indicated in the RRC signaling.

After receiving the SSSG switching capability reported by the first-category UE, the network device allocates the target switching delay to the first-category UE via the RRC signaling searchSpaceSwitchingDelay-R16. After receiving the SSSG switching capability reported by the second-category UE, the network device allocates the target switching delay to the second-category UE via the RRC signaling searchSpaceSwitchingDelay-R18.

In S502, the target switching delay is sent to the UE according to the minimum switching delay corresponding to the search space set group switching capability.

Reference may be made to S102 for an embodiment of this step, which is not repeated here.

By using the above technical solutions, the network device may determine the SSSG switching capability of the UE explicitly, sending the target switching delay to the UE according to the minimum switching delay corresponding to the SSSG switching capability of the UE.

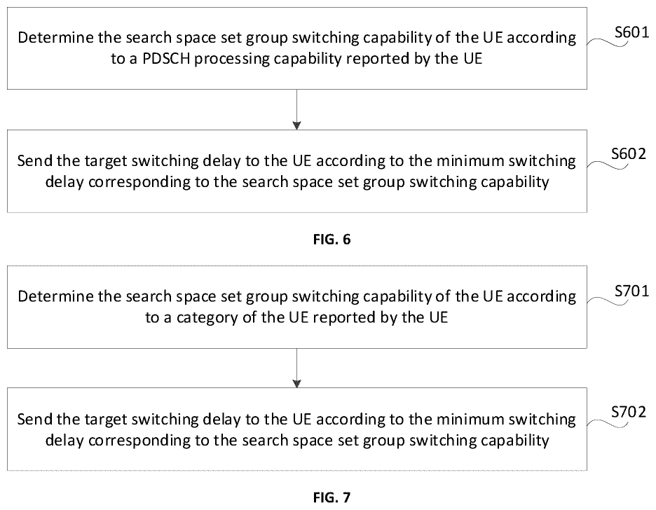

FIG. 6 is a flowchart of a method for determining the switching delay according to an example. The method for determining the switching delay is applied to the network device. As shown in FIG. 6, the method for determining the switching delay includes the following steps.

In S601, the search space set group switching capability of the UE is determined according to a PDSCH processing capability reported by the UE.

In a case where the second-category UE has the first switching capability, the second switching capability, and the third switching capability, and the network device needs to determine the switching capability currently used by the UE, the PDSCH processing capability of the UE may be reported to the network device by the UE, and the SSSG switching capability of the UE may be determined according to the PDSCH processing capability implicitly.

The PDSCH processing capability includes a first PDSCH processing capability, a second PDSCH processing capability and a third PDSCH processing capability. The first PDSCH processing capability is less than the second PDSCH processing capability. The third PDSCH processing capability is less than the first PDSCH processing capability. The second PDSCH processing capability is the unrelaxed processing capability. The first PDSCH processing capability is the normally reduced processing capability. The third PDSCH processing capability is the evolved reduced processing capability.

The UE may report its own switching capability to the network device implicitly. For example, the network device may receive the PDSCH processing capability reported by the UE, and determine the SSSG switching capability of the UE according to the PDSCH processing capability. The PDSCH processing capability includes any one of the first PDSCH processing capability, the second PDSCH processing capability, and the third PDSCH processing capability.

For example, in a case where the network device receives the first PDSCH processing capability reported by the UE, the network device may determine that the SSSG switching capability of the UE is the first switching capability implicitly. In a case where the network device receives the second PDSCH processing capability reported by the UE, the network device may determine that the SSSG switching capability of the UE is the second switching capability implicitly. In a case where the network device receives the third PDSCH processing capability reported by the UE, the network device may determine that the SSSG switching capability of the UE is the third switching capability implicitly.

The first-category UE has the first PDSCH processing capability and the second PDSCH processing capability. For example, both the Normal UE and the RedCap UE have the first PDSCH processing capability and the second PDSCH processing capability. The second-category UE has the first PDSCH processing capability, the second PDSCH processing capability, and the third PDSCH processing capability. For example, the eRedCap UE has the first PDSCH processing capability, the second PDSCH processing capability, and the third PDSCH processing capability.

In S602, the target switching delay is sent to the UE according to the minimum switching delay corresponding to the search space set group switching capability.

Reference may be made to S102 for an embodiment of this step, which is not repeated here.

By the above technical solutions, the PDSCH processing capability of the UE is reported to the network device by the UE, the network device may determine the SSSG switching capability of the UE according to the PDSCH processing capability implicitly, to send the target switching delay to the UE according to the minimum switching delay corresponding to the SSSG switching capability of the UE.

FIG. 7 is a flowchart of a method for determining the switching delay according to an example. The method for determining the switching delay is applied to the network device. As shown in FIG. 7, the method for determining the switching delay includes the following steps.

In S701, the search space set group switching capability of the UE is determined according to a category of the UE reported by the UE.

The category of the UE includes the first-category UE non-eRedCap UE and the second-category UE eRedCap UE. The first-category UE includes the Normal UE and the RedCap UE.

In a case where the eRedCap UE of the second-category UE has the third processing capability, and the network device needs to determine the switching capability currently used by the UE, the UE may report the category of the UE to the network device, and the network device may determine the SSSG switching capability of the UE according to the category of the UE implicitly.

The UE may report its own switching capability to the network device implicitly. For example, the network device receives the category of the UE reported by the UE, and determines the search space set group switching capability of the UE according to the category of the UE.

For example, in a case where the category of the UE reported by the UE and received by the network device is the eRedCap UE, the network device may determine that the SSSG switching capability of the UE is the third switching capability implicitly.

In S702, the target switching delay is sent to the UE according to the minimum switching delay corresponding to the search space set group switching capability.

Reference may be made to S102 for an embodiment of this step, which is not repeated here.

By the above technical solutions, the category of the UE is reported to the network device by the UE, the network device may determine the SSSG switching capability of the UE according to the category of the UE implicitly, to send the target switching delay to the UE according to the minimum switching delay corresponding to the SSSG switching capability of the UE.

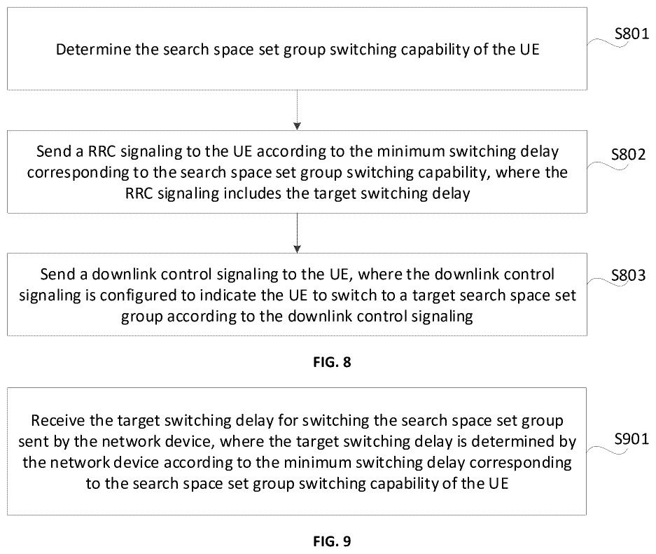

FIG. 8 is a flowchart of a method for determining the switching delay according to an example. The method for determining the switching delay is applied to the network device. As shown in FIG. 8, the method for determining the switching delay includes the following steps. S802 and S803 may be performed simultaneously or separately by the network device.

In S801, the search space set group switching capability of the UE is determined.

Reference may be made to S101 for an embodiment of this step, which is not repeated here.

In S802, a RRC signaling is sent to the UE according to the minimum switching delay corresponding to the search space set group switching capability, where the RRC signaling includes the target switching delay.

The network device receives the switching capability reported by the UE via UE capability signaling. The UE capability signaling is one category of the RRC signaling. The network device determines the minimum switching delay according to the switching capability carried in the UE capability signaling, configures the target switching delay greater than or equal to the minimum switching delay in the RRC signaling, and sends the RRC signaling to the UE.

The UE switches the SSSG according to duration indicated in the target switching delay.

In S803, a downlink control signaling is sent to the UE, where the downlink control signaling is configured to indicate the UE to switch to a target search space set group according to the downlink control signaling.

The network device not only sends the RRC signaling, but also sends DCI signaling (downlink control signaling) to indicate the UE to switch to the target SSSG with the target switching delay according to the target SSSG carried in the DCI signaling, and monitor the PDCCH with the target SSSG.

The target SSSG includes a periodically sparse SSSG and a periodically dense SSSG. The UE monitors the PDCCH with a sparser period by using the periodically sparse SSSG. The UE monitors the PDCCH with a denser period by using the periodically dense SSSG.

The UE is within a network coverage range of the network device, such that the network device is aware of whether a service of each UE is busy. In a case where the service of the UE is busy, the periodically dense SSSG may be sent to the UE with a busy service, such that the UE with the busy service monitors the PDCCH with a denser period by using the SSSG. In a case where the service of the UE is idle, the periodically sparse SSSG may be sent to the UE with a sparse service, such that the UE with the sparse service monitors the PDCCH with the sparser period by using the SSSG.

The network device may indicate the UE to switch the SSSG explicitly or implicitly via the DCI signaling.

Illustratively, the network device may directly carry the target SSSG in the DCI signaling to indicate the UE to switch to the target SSSG. The network device may also configure a timer in the DCI signaling. That is, the PDCCH is monitored by using configuration of one SSSG during running of the timer. The PDCCH is monitored by using configuration of another SSSG when the timer runs to another period.

By the above technical solution, the network device may send the RRC signaling and the DCI signaling, such that the UE switches to the target SSSG after the target switching delay, according to the target switching delay indicated in the RRC signaling and the target SSSG in the DCI signaling.

FIG. 9 is a flowchart of a method for determining the switching delay according to an example. The method for determining the switching delay is applied to UE. As shown in FIG. 9, the method for determining the switching delay includes the following steps.

In S901, the target switching delay for switching the search space set group sent by the network device is received, where the target switching delay is determined by the network device according to the minimum switching delay corresponding to the search space set group switching capability of the UE.

The SSSG switching capability of the UE corresponds to the plurality of minimum switching delays. Minimum switching delays corresponding to one SSSG switching capability are equal or not.

With reference to Table 2, the network device determines the plurality of minimum switching delays according to the SSSG switching capability of the UE, and then determines the minimum switching delay from the plurality of minimum switching delays according to the μ value of the UE. After determining the minimum switching delay, the network device sends the target switching delay greater than or equal to the minimum switching delay and less than the maximum switching delay to the UE. The UE switches the SSSG with the target switching delay.

Reference may be made to S101 and S102 for S901, which is not repeated here.

By the above technical solutions, the network device may determine the SSSG switching capability of the UE, determine the minimum switching delay corresponding to the SSSG switching capability, and send the target switching delay to the UE according to the minimum switching delay. In this process, after the processing capability of the UE is reduced, the network device may also re-determine the processing capability of the UE, and send the target switching delay to the UE according to the minimum switching delay corresponding to the reduced processing capability of the UE. So that the UE with the reduced processing capability can receive the corresponding target switching delay, and a situation that the target switching delay received by the UE is not aligned with the target switching delay configured by the network device can be avoided.

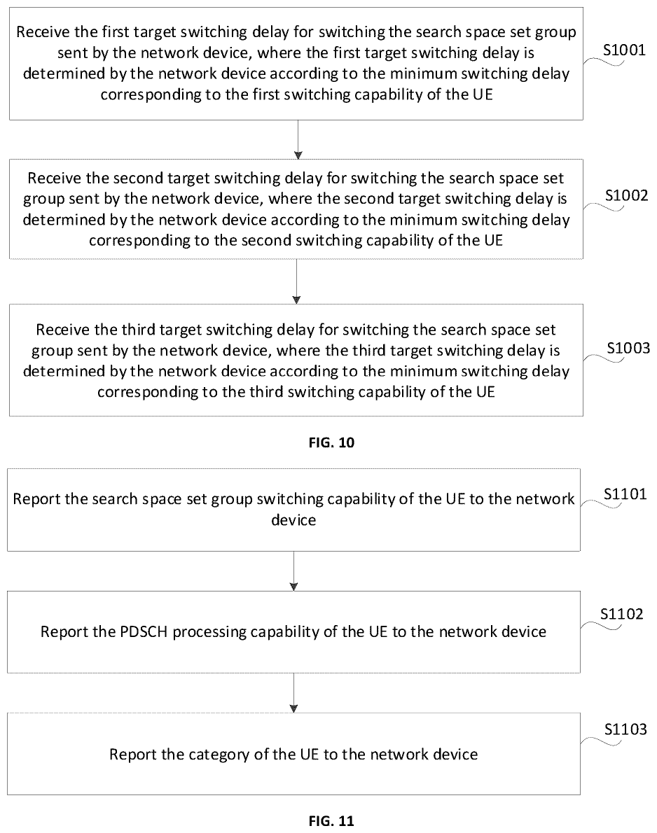

FIG. 10 is a flowchart of a method for determining the switching delay according to an example. The method for determining the switching delay is applied to the UE. As shown in FIG. 10, the method for determining the switching delay includes at least one of S1001, S1002, or S1003.

In S1001, the first target switching delay for switching the search space set group sent by the network device is received, where the first target switching delay is determined by the network device according to the minimum switching delay corresponding to the first switching capability of the UE.

Reference may be made to S203 for this step, which is not repeated here.

S1002, the second target switching delay for switching the search space set group sent by the network device is received, where the second target switching delay is determined by the network device according to the minimum switching delay corresponding to the second switching capability of the UE.

Reference may be made to S202 for this step, which is not repeated here.

In S1003, the third target switching delay for switching the search space set group sent by the network device is received, where the third target switching delay is determined by the network device according to the minimum switching delay corresponding to the third switching capability of the UE.

The first target switching delay is greater than the second target switching delay, and the third target switching delay is greater than the first target switching delay.

Reference may be made to S204 for this step, which is not repeated here.

By the above technical solutions, in a case where the first switching capability or the second switching capability of the first-category UE is determined, the network device sends the first target switching delay or the second target switching delay to the first-category UE according to the minimum switching delay corresponding to the first switching capability or the second switching capability. In a case where the first switching capability, the second switching capability or the third switching capability of the second-category UE is determined, the network device sends the first target switching delay, the second target switching delay or the third target switching delay to the second-category UE according to the minimum switching delay corresponding to the first switching capability, the second switching capability or the third switching capability. Accordingly, the first-category UE and the second-category UE with different processing capabilities can obtain corresponding target switching delays respectively. A situation that the target switching delay configured by the network device is not aligned with the switching delay needed by the UE is avoided.

FIG. 11 is a flowchart of a method for determining the switching delay according to an example. The method for determining the switching delay is applied to the UE. As shown in FIG. 11, the method for determining the switching delay includes at least one of S1101, S1102, or S1103.

In S1101, the search space set group switching capability of the UE is reported to the network device.

Reference may be made to S501 for this step, which is not repeated here.

In S1102, the PDSCH processing capability of the UE is reported to the network device.

Reference may be made to S601 for this step, which is not repeated here.

In S1103, the category of the UE is reported to the network device.

Reference may be made to S701 for this step, which is not repeated here.

By the above technical solutions, at least one of the switching capability, the PDSCH processing capability, or the category of the UE is reported to the network device by the UE, the network device may determine the SSSG switching capability of the UE according to at least one of the switching capability, the PDSCH processing capability, or the category of the UE, to send the target switching delay to the UE according to the minimum switching delay corresponding to the SSSG switching capability of the UE.

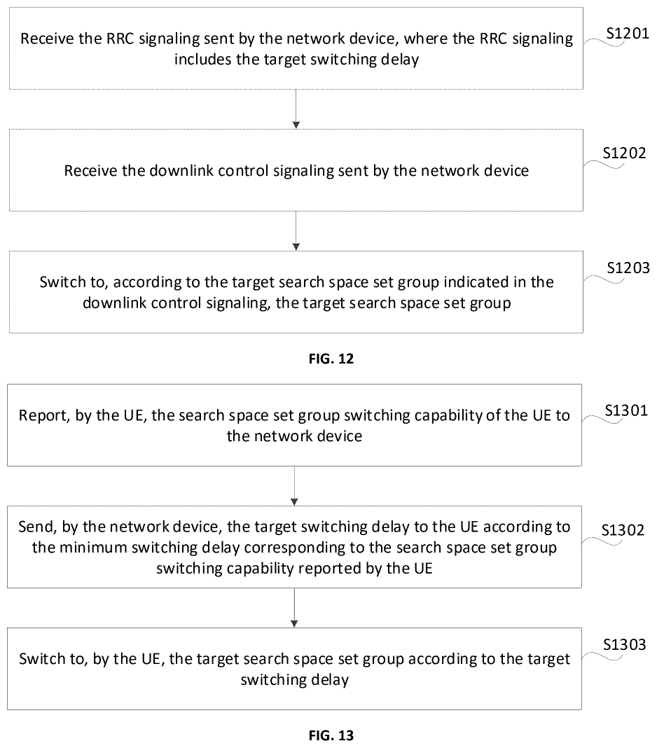

FIG. 12 is a flowchart of a method for determining the switching delay according to an example. The method for determining the switching delay is applied to the UE. As shown in FIG. 12, the method for determining the switching delay includes the following steps.

In S1201, the RRC signaling sent by the network device is received, where the RRC signaling includes the target switching delay.

Reference may be made to S802 for this step, which is not repeated here.

In S1202, the downlink control signaling sent by the network device is received.

Reference may be made to S803 for this step, which is not repeated here.

In S1203, the target search space set group is switched to, according to the target search space set group indicated in the downlink control signaling.

Reference may be made to S803 for this step, which is not repeated here.

By the above technical solution, the network device may configure the RRC signaling and the DCI signaling, such that the UE switches to the target SSSG after the target switching delay according to the target switching delay indicated in the RRC signaling and the target SSSG in the DCI signaling.

FIG. 13 shows a method for determining the switching delay according to an example. The method is applied to the UE and the network device. The method includes the following steps.

In 1301, the search space set group switching capability of the UE is reported by the UE to the network device.

The UE may report the SSSG switching capability of the UE to the network device in at least one of the following ways: the UE directly reports the SSSG switching capability to the network device, the UE reports the PDSCH processing capability of the UE to the network device, and the UE reports the category of the UE to the network device.

Reference may be made to S501 for a process of directly reporting the SSSG switching capability of the UE to the network device by the UE, which is not repeated here.

Reference may be made to S601 for a process of reporting the PDSCH processing capability of the UE to the network device by the UE, which is not repeated here.

Reference may be made to S701 for a process of reporting the category of the UE to the network device by the UE, which is not repeated here.

In S1302, the target switching delay is sent by the network device to the UE, according to the minimum switching delay corresponding to the search space set group switching capability reported by the UE.

Reference may be made to S102 for this step, which is not repeated here.

In S1303, the target search space set group switched to by the UE, according to the target switching delay.

Reference may be made to S803 for this step, which is not repeated here.

By the above technical solutions, the network device may determine the SSSG switching capability of the UE, determine the minimum switching delay corresponding to the SSSG switching capability, and send the target switching delay to the UE according to the minimum switching delay. The UE switches to the target SSSG with the target switching delay. In this process, after the processing capability of the UE is reduced, the network device may also re-determine the processing capability of the UE, and send the target switching delay to the UE according to the minimum switching delay corresponding to the reduced processing capability of the UE. So that the UE with the reduced processing capability can receive an increased target switching delay, and the situation that the target switching delay needed by the UE is not aligned with the target switching delay configured by the network device can be avoided.

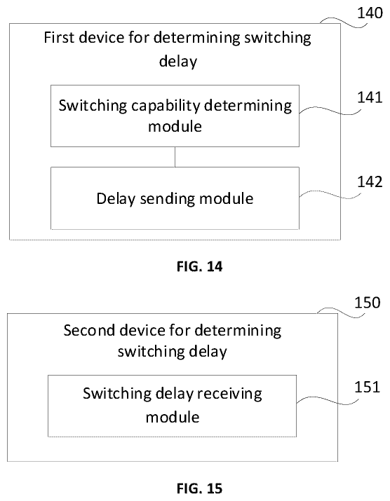

FIG. 14 is a block diagram of a first device for determining the switching delay according to an example. The first device for determining the switching delay is applied to the network device. As shown in FIG. 14, the first device 140 for determining the switching delay includes:
a switching capability determining module 141 configured to determine a search space set group switching capability of a user equipment (UE); and
a delay sending module 142 configured to send a target switching delay to the UE according to a minimum switching delay corresponding to the search space set group switching capability.

Optionally, the search space set group switching capability includes at least one of a first switching capability, a second switching capability or a third switching capability. The UE includes at least one of a first-category UE and a second-category UE. The delay sending module 142 includes at least one of:
a first delay sending module configured to send a first target switching delay to at least one of the first-category UE or the second-category UE, according to a minimum switching delay corresponding to the first switching capability;
a second delay sending module configured to send a second target switching delay to at least one of the first-category UE or the second-category UE, according to a minimum switching delay corresponding to the second switching capability; or
a third delay sending module configured to send a third target switching delay to the second-category UE according to a minimum switching delay corresponding to the third switching capability, where
the first target switching delay is greater than the second target switching delay, and the third target switching delay is greater than the first target switching delay.

Optionally, the delay sending module 142 includes:
a fourth delay sending module configured to send the target switching delay to the UE according to the minimum switching delay corresponding to the search space set group switching capability and a sub-carrier spacing of a bandwidth of the UE.

Optionally, the first device 140 for determining the switching delay includes:
a fifth delay sending module configured to send the target switching delay to the UE according to a minimum switching delay corresponding to a sub-carrier spacing of a bandwidth of the UE, in a case where a category of the UE is a target category.

Optionally, a switching duration of the target switching delay is greater than or equal to a switching duration of the minimum switching delay.

Optionally, the switching capability determining module 141 includes:
a first switching capability determining module configured to receive the search space set group switching capability reported by the UE.

Optionally, the switching capability determining module 141 includes:
a PDSCH processing capability receiving module configured to receive a PDSCH processing capability reported by the UE; and
a second switching capability determining module configured to determine the search space set group switching capability of the UE according to the PDSCH processing capability.

Optionally, the switching capability determining module 141 includes:
a terminal category receiving module configured to receive a category of the UE reported by the UE; and
a third switching capability determining module configured to determine the search space set group switching capability of the UE according to the category of the UE.

Optionally, the delay sending module 142 includes:
a RRC signaling sending module configured to send a RRC signaling to the UE according to the minimum switching delay corresponding to the search space set group switching capability, where the RRC signaling includes the target switching delay.

Optionally, the first device 140 for determining the switching delay includes:
a downlink control signaling sending module configured to send a downlink control signaling to the UE, where the downlink control signaling is configured to indicate the UE to switch to a target search space set group according to the downlink control signaling.

FIG. 15 is a block diagram of a second device for determining the switching delay according to an example. The second device for determining the switching delay is applied to the UE. As shown in FIG. 15, the second device 150 for determining the switching delay includes:
a switching delay receiving module 151 configured to receive a target switching delay for switching a search space set group sent by a network device, where the target switching delay is determined by the network device according to a minimum switching delay corresponding to a search space set group switching capability of the UE.

Optionally, the switching delay receiving module 151 includes at least one of:
a first switching delay receiving module configured to receive a first target switching delay for switching the search space set group sent by the network device, where the first target switching delay is determined by the network device according to a minimum switching delay corresponding to a first switching capability of the UE;
a second switching delay receiving module configured to receive a second target switching delay for switching the search space set group sent by the network device, where the second target switching delay is determined by the network device according to a minimum switching delay corresponding to a second switching capability of the UE; or
a third switching delay receiving module configured to receive a third target switching delay for switching the search space set group sent by the network device, where the third target switching delay is determined by the network device according to a minimum switching delay corresponding to a third switching capability of the UE, where
the first target switching delay is greater than the second target switching delay, and the third target switching delay is greater than the first target switching delay.

Optionally, the second device 150 for determining the switching delay includes:
a switching capability reporting module configured to report the search space set group switching capability of the UE to the network device.

Optionally, the second device 150 for determining the switching delay includes:
a PDSCH processing capability reporting module configured to report a PDSCH processing capability of the UE to the network device.

Optionally, the second device 150 for determining the switching delay includes:
a terminal category reporting module configured to report a category of the UE to the network device.

Optionally, the second device 150 for determining the switching delay includes:
a RRC signaling receiving module configured to receive a RRC signaling sent by the network device, where the RRC signaling includes the target switching delay.

Optionally, the second device 150 for determining the switching delay includes:
a downlink control signaling receiving module configured to receive a downlink control signaling sent by the network device; and
a switching module configured to switch to, according to the target search space set group indicated in the downlink control signaling, the target search space set group.

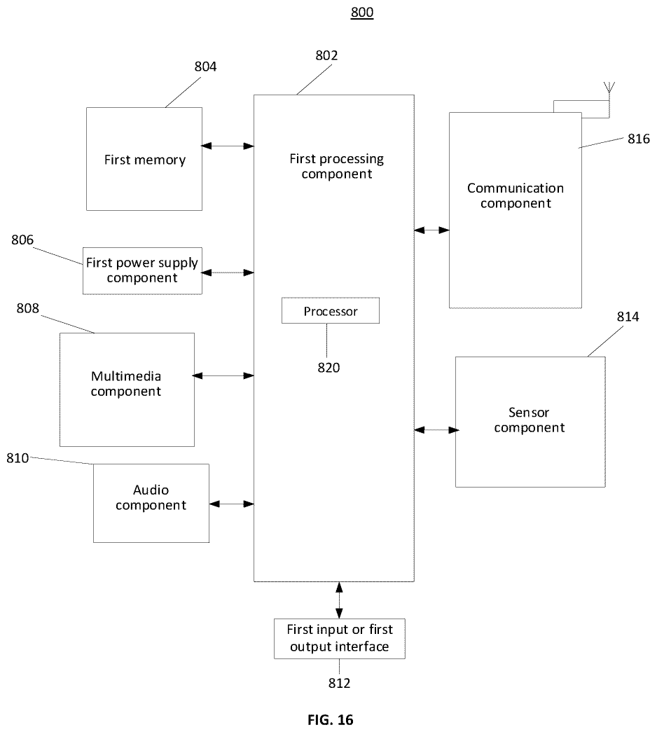

FIG. 16 is a block diagram of a user equipment (UE) 800 according to an example. For example, the UE 800 may be a mobile phone, a computer, a digital broadcast terminal, a message transceiving device, a gaming console, a tablet device, a medical device, a fitness device, or a personal digital assistant, etc.

With reference to FIG. 16, the UE 800 may include one or more of a first processing component 802, a first memory 804, a first power supply component 806, a multimedia component 808, an audio component 810, a first input or first output interface 812, a sensor component 814, and a communication component 816.

The first processing component 802 generally controls overall operations of the UE 800, for example, operations associated with display, phone calls, data communication, camera operations, and recording operations. The first processing component 802 may include one or more processors 820 to execute instructions, so as to complete all or some steps of the method above. Moreover, the first processing component 802 may include one or more modules that facilitate interaction between the first processing component 802 and other components. For example, the first processing component 802 may include a multimedia module, so as to facilitate interaction between the multimedia component 808 and the first processing component 802.

The first memory 804 is configured to store various types of data to support the operations on the UE 800. Instances of such data include an instruction, operated on the UE 800, for any application or method, contact data, phonebook data, messages, pictures, videos, etc. The first memory 804 may be implemented through any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, and an optical disk.

The first power supply component 806 supplies power to the various components of the UE 800. The first power supply component 806 may include a power supply management system, one or more power supplies, and other components associated with power generation, management, and distribution for the UE 800.

The multimedia component 808 includes a screen that provides an output interface between the UE 800 and a user. In some embodiments, the screen may include a liquid crystal display (LCD) and a touch panel (TP). In a case of including the touch panel, the screen may be implemented as a touch screen, so as to receive an input signal from the user. The touch panel includes one or more touch sensors, so as to sense touches, swipes, and gestures on the touch panel. The touch sensor may sense a boundary of a touch or swipe action and measure time and pressure associated with a touch or swipe operation. In some embodiments, the multimedia component 808 includes a front-facing camera and/or a rear-facing camera. When the UE 800 is in an operation mode, such as a photographing mode or a video mode, the front-facing camera and/or the rear-facing camera may receive external multimedia data. Each of the front-facing camera and the rear-facing camera may be a fixed optical lens system or have a focal length and an optical zoom capability.

The audio component 810 is configured to output and/or input audio signals. For example, the audio component 810 includes a microphone (MIC) configured to receive external audio signals when the UE 800 is in the operation mode, for example, a calling mode, a recording mode, or a speech recognition mode. The audio signals received may be further stored in the first memory 804 or sent via the communication component 816. In some embodiments, the audio component 810 further includes a speaker used to output an audio signal.

The first input or first output interface 812 provides an interface between the first processing component 802 and a peripheral interface module, which may be a keyboard, a click wheel, a button, etc. These buttons may include, but are not limited to, a home button, a volume button, a start button, and a lock button.

The sensor component 814 includes one or more sensors for providing state assessments of various aspects for the UE 800. For example, the sensor component 814 may detect an on/off state of the UE 800 and relative positioning of the components. For example, the components are a display and a keypad of the UE 800. The sensor component 814 may also detect a change in position of the UE 800 or a component of the UE 800, the presence or absence of contact between the user and the UE 800, orientation or acceleration/deceleration of the UE 800, and temperature variation of the UE 800. The sensor component 814 may include a proximity sensor configured to detect presence of nearby objects in absence of any physical contact. The sensor component 814 may further include a light sensor, such as a complementary metal-oxide-semiconductor transistor (CMOS) or charge coupled device (CCD) image sensor for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access a wireless network based on a communication standard, for example, Wi-Fi, 2G, or 3G, or their combinations. In an example, the communication component 816 receives a broadcast signal or broadcast related information from an external broadcast management system via a broadcast channel. In an example, the communication component 816 further includes a near field communication (NFC) module, so as to facilitate short-range communication. For example, the NFC module may be implemented based on a radio frequency identification (RFID) technology, an infrared data association (IrDA) technology, an ultra wide band (UWB) technology, a Bluetooth (BT) technology, etc.

In an example, the UE 800 may be configured to perform the above method by being implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, etc.

A non-transitory computer-readable storage medium including instructions, for example, the first memory 804 including an instruction is further provided in an example. The above instructions may complete the above method by being executed by the processor 820 of the UE 800. For example, the non-transitory computer-readable storage medium may be an ROM, a random access memory (RAM), a compact disk read-only memory (CD-ROM), a magnetic tape, a floppy disk, an optical data storage device, etc.

The above device may be a part of a separate electronic device besides a separate electronic device. For example, in one embodiment, the device may be an integrated circuit (IC) or a chip, where the integrated circuit may be an IC or a set of a plurality of ICs; and the chip may include, but is not limited to, the following categories: a graphics processing unit (GPU), a central processing unit (CPU), a field programmable gate array (FPGA), a digital signal processor (DSP), an application specific integrated circuit (ASIC), a system on chip (SOC), etc. The above integrated circuit or chip may be configured to execute executable instructions (or codes), so as to implement the method for determining the switching delay. The executable instructions may be stored on the integrated circuit or chip or retrieved from another device or device. For example, the integrated circuit or chip includes a processor, a memory, and an interface for communicating with another device. The executable instructions may be stored in the memory, and the above method may be implemented to determine the switching delay when executed by the processor. Alternatively, the integrated circuit or chip may receive the executable instructions through the interface and send the executable instructions to the processor for execution, so as to implement the above method for determining the switching delay.

In another example, a computer program product is further provided. The computer program product includes a computer program executable by a programmable device, and the computer program has a code portion for performing the method for determining the switching delay when executed by the programmable device.

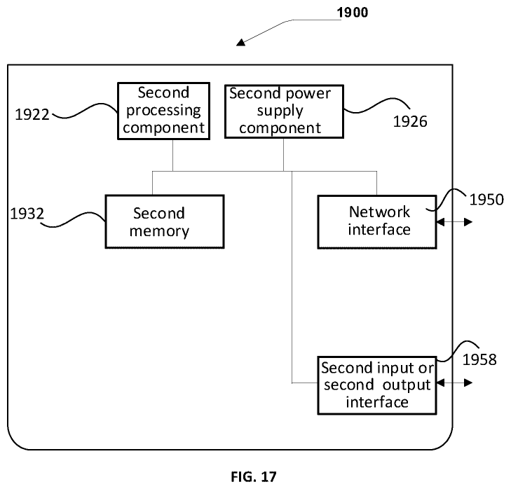

FIG. 17 is a block diagram of a network device 1900 according to an example. For example, the network device 1900 may be provided as a station. With reference to FIG. 17, the network device includes a second processing component 1922, and further includes one or more processors and memory resources represented by a second memory 1932 and configured to store instructions executable by the second processing component 1922, for example, an application. The application stored in the second memory 1932 may include one or more modules, each of which corresponds to a set of instructions. Further, the second processing component 1922 is configured to execute the instructions to implement the above method for determining the switching delay.

The network device 1900 may further include a second power supply component 1926 configured to perform power component management of the network device 1900, a wired or wireless network interface 1950 configured to connect the network device 1900 to a network, and a second input or second output interface 1958.

As used herein, the term processor may refer to one processor that performs the defined functions or a plurality of processors that collectively perform defined functions, such that the execution of the individual defined functions may be divided amongst such processors.

Those skilled in the art will readily conceive of other implementation solutions of the present disclosure after considering the description and practicing the present disclosure. The disclosure is intended to cover any variations, uses, or adaptive changes of the disclosure that follow the general principles of the disclosure and include common general knowledge or customary technical means in the art not disclosed in the present disclosure. The description and embodiments are merely deemed illustrative, and the true scope and spirit of the present disclosure are indicated by the following claims.

It should be understood that the present disclosure is not limited to the precise structure that has been described above and shown in the accompanying drawings, and that various modifications and changes may be made without departing from its scope. The scope of the present disclosure is limited merely by the appended claims.

1. A method for determining a switching delay performed by a network device, the method comprising:
determining a search space set group switching capability of a user equipment (UE); and
sending a target switching delay to the UE according to a minimum switching delay corresponding to the search space set group switching capability.

2. The method according to claim 1, wherein the search space set group switching capability comprises at least one of a first switching capability, a second switching capability or a third switching capability, and the UE comprises at least one of a first-category UE or a second-category UE, and
sending the target switching delay to the UE according to the minimum switching delay corresponding to the search space set group switching capability comprises at least one of:
sending a first target switching delay to at least one of the first-category UE or the second-category UE, according to a minimum switching delay corresponding to the first switching capability;
sending a second target switching delay to at least one of the first-category UE or the second-category UE, according to a minimum switching delay corresponding to the second switching capability; or
sending a third target switching delay to the second-category UE according to a minimum switching delay corresponding to the third switching capability;
wherein the first target switching delay is greater than the second target switching delay, and the third target switching delay is greater than the first target switching delay.

3. The method according to claim 1, wherein sending the target switching delay to the UE according to the minimum switching delay corresponding to the search space set group switching capability comprises:
sending the target switching delay to the UE according to the minimum switching delay corresponding to the search space set group switching capability and a sub-carrier spacing of a bandwidth of the UE.

4. The method according to claim 1, further comprising:
sending the target switching delay to the UE according to a minimum switching delay corresponding to a sub-carrier spacing of a bandwidth of the UE, in a case where a category of the UE is a target category.

5. The method according to claim 1, wherein a switching duration of the target switching delay is greater than or equal to a switching duration of the minimum switching delay.

6. The method according to claim 1, wherein determining the search space set group switching capability of the UE comprises:
receiving the search space set group switching capability reported by the UE.

7. The method according to claim 1, wherein determining the search space set group switching capability of the UE comprises:
receiving a physical downlink shared channel (PDSCH) processing capability reported by the UE; and
determining the search space set group switching capability of the UE according to the PDSCH processing capability.

8. The method according to claim 1, wherein determining the search space set group switching capability of the UE comprises:
receiving a category of the UE reported by the UE; and
determining the search space set group switching capability of the UE according to the category of the UE.

9. The method according to claim 1, wherein sending the target switching delay to the UE according to the minimum switching delay corresponding to the search space set group switching capability comprises:
sending a radio resource control (RRC) signaling to the UE according to the minimum switching delay corresponding to the search space set group switching capability, wherein the RRC signaling includes the target switching delay.

10. The method according to claim 1, further comprising:
sending a downlink control signaling to the UE, wherein the downlink control signaling is configured to indicate the UE to switch to a target search space set group according to the downlink control signaling.

11. A method for determining a switching delay performed by a user equipment (UE), the method comprising:
receiving a target switching delay for switching a search space set group sent by a network device, wherein the target switching delay is determined by the network device according to a minimum switching delay corresponding to a search space set group switching capability of the UE.

12. The method according to claim 11, wherein receiving the target switching delay for switching the search space set group sent by the network device comprises at least one of:
receiving a first target switching delay for switching the search space set group sent by the network device, wherein the first target switching delay is determined by the network device according to a minimum switching delay corresponding to a first switching capability of the UE;
receiving a second target switching delay for switching the search space set group sent by the network device, wherein the second target switching delay is determined by the network device according to a minimum switching delay corresponding to a second switching capability of the UE; or
receiving a third target switching delay for switching the search space set group sent by the network device, wherein the third target switching delay is determined by the network device according to a minimum switching delay corresponding to a third switching capability of the UE;
wherein the first target switching delay is greater than the second target switching delay, and the third target switching delay is greater than the first target switching delay.

13. The method according to claim 11, wherein before receiving the target switching delay for switching the search space set group sent by the network device, the method further comprises:
reporting the search space set group switching capability of the UE to the network device.

14. The method according to claim 11, wherein before receiving the target switching delay for switching the search space set group sent by the network device, the method further comprises:
reporting a physical downlink shared channel (PDSCH) processing capability of the UE to the network device.

15. The method according to claim 11, wherein before receiving the target switching delay for switching the search space set group sent by the network device, the method further comprises:
reporting a category of the UE to the network device.

16. The method according to claim 11, further comprising:
receiving a radio resource control RRC signaling sent by the network device, wherein the RRC signaling includes the target switching delay.

17. The method according to claim 11, further comprising:
receiving a downlink control signaling sent by the network device; and
switching to a target search space set group, according to the target search space set group indicated in the downlink control signaling.

18-19. (canceled)

20. A network device, comprising:
one or more processors, and
a memory that stores executable instructions,
wherein
the executable instructions when collectively executed by the one or more processors cause the network device to:
determine a search space set group switching capability of a user equipment (UE); and
send a target switching delay to the UE according to a minimum switching delay corresponding to the search space set group switching capability.

21. A communication device, comprising:
one or more processors, and
a memory that stores executable instructions,
wherein
the executable instructions when collectively executed by the one or more processors cause the communication device to act as the user equipment (UE) and perform the method according to claim 11.

22. A non-transitory computer-readable storage medium storing computer program instructions, wherein the program instructions, when executed by a processor of the network device, cause the network device to perform the method according to claim 1.

23. (canceled)
